(19) United States
(12) Patent Application Publication
(10) Pub. No.: US 2022/0333742 A1
(43) Pub. Date: Oct. 20, 2022

(54) LEAK-PROOF FLUID DISPENSING SYSTEM WITH PRESSURE SENSOR AND PRE-SET INTERNAL DISPENSING PRESSURE REDUCTION REGULATOR AND DISPENSING CONTROL VALVE STRUCTURE

(71) Applicant: Stuart James Muller, Rowley, MA (US)

(72) Inventor: Stuart James Muller, Rowley, MA (US)

(21) Appl. No.: 17/232,562

(22) Filed: Apr. 16, 2021

(51) Int. Cl. F17C 13/04; F16K 1/30

(52) U.S. Cl. CPC F17C 13/04; F16K 1/30; F17C 2205/0323; F17C 2205/0338; F17C 2205/0341

(57) ABSTRACT

The present invention provides a leak-proof fluid dispensing system with pressure sensor and pre-set and fixed dispensing pressure reducing regulator including a gas cylinder having a containing space, a pressure sensor and a dispensing control valve. The dispensing control valve having internal channels that communicate with an inlet port, an outlet port, a bottle port, a pressure sensor and a joint portion so that the bottle port is communicated with the containing cylinder space.

The leak-proof fluid dispensing system includes an inlet valve connected to the inlet port and the internal channel, an outlet valve connected to the outlet port and the internal channel, a pressure dispensing reducing regulator connected to the outlet port and the bottle port through the internal channel and preset and fixed with an opening pressure value. When the actual pressure at the outlet end of the pressure dispensing regulator is lower than or equal to the opening pressure value, then the pressure dispensing regulator is being opened. A pressure sensor disposed on the dispensing body and having pressure sensitively is connected to the internal channel and the bottle port.

With the implementation of the present invention, it may prevent accidental leakage of fluid in the gas cylinder and dynamically monitor the flow gas capacity in the gas cylinder.

### CROSS-REFERENCE TO RELATED APPLICATIONS

The present application claims priority to provisional patent application No. 63/015,609 filed on Apr. 26, 2020, disclosures of which are incorporated herein at least by reference.

### BACKGROUND OF THE INVENTION

### 1. Field of the Invention

The present invention relates to a leak-proof fluid dispensing system with pre-set internal dispensing pressure reduction regulator and, dispensing control valve structure with active pressure sensor, and dispensing control valve structure. This invention is particularly designed for the safe storage and distribution of toxic specialty gases such as a compressed gas or liquefied compressed gas when using a storage container and a dispensing system, while monitoring the active cylinder gas pressure and available gas volume.

### 2. Description of Related Art

In various industrial processes and applications, reliable hazardous and non-hazardous processing fluids are often required. For example, in semiconductor manufacturing, ion implantation, manufacturing of flat panel displays, medical interventions and treatment, water treatment, emergency breathing equipment, welding operations, liquid and gas transportation in space bases, etc., all need safe, reliable and efficient processing fluids to supply continuously to complete the relevant production or operation.

Toxic gases and other harmful special gases are often used in many industrial processing, including the manufacture of semiconductor components because these gases can cause huge harm to humans, animals or the environment so that users of these harmful special gases will worry about the possibility of gas release by accident.

Standard compressed gas cylinder contains super atmospheric pressure gas. Once the user end is connected to a pressurized gas cylinder and the outlet valve is opened, then the gas in the gas cylinder will be immediately released, even if the user installs the leak-proof outlet cover to meet the requirements for using dangerous gases. However, if the valve is accidentally opened when the outlet cover is removed, then it will cause serious casualties.

Although such incidents are not expected to happen, accidental leakages of harmful gases may still occur in semiconductor processing applications. Once such leakage events occur, some or all of the people must be immediately evacuated from semiconductor processing factory, which will lead to suddenly unplanned shutdown of the production line and a large number of scraps of products and other losses. Moreover, sensitive and expensive equipment used in semiconductor processing plants may also be damaged by exposure to harmful gases.

In order to avoid the occurrence of the above mentioned harmful gas leakage events, many semiconductor manufacturing processes, such as ion implantation, chemical vapor deposition, reactive ion etching, high-density plasma etching, etc., use harmful sub-atmospheric pressure gas supply system all the time.

One such sub-atmospheric gas supply system integrates the pressure reduction regulator mechanism into the cylinder delivery valve body. In such case, a limitation of sub-atmospheric supply systems are cylinders that allow user access to the external regulator pressure reduction adjustment. Any such uncontrolled tampering of the factory pre-set pressure reduction regulator settings by the user creates a potential safety hazard. Such improper settings could cause operator injury, equipment damage or unwanted gas release.

Another sub-atmospheric gas supply system insert the pressure reduction bellows regulator/mechanism into the cylinder delivery valve body as an independent component. In these cases, the pressure reduction bellows regulator is generally pre-fixed as access to the component is not possible after the cylinder package is assembled. Another limitation is there is no way to actively monitor the available cylinder pressure remaining inside the cylinder.

Another sub-atmospheric gas supply system configures the pressure reduction regulator mechanism into the cylinder body, external of the cylinder valve. In these cases, the pressure reduction regulator is generally pre-fixed as access to the component is not possible when the cylinder package is assembled. Another limitation is there is no way to actively monitor the available cylinder pressure remaining inside the cylinder.

A limitation with current sub-atmospheric gas supply systems, where there is no way to monitor the available cylinder pressure remaining inside the cylinder prevents the user from obtaining the actual active cylinder pressure. The user only has access to the downstream pressure values after the dispensing pressure reducing regulator has already reduced the cylinder pressure to a lower delivery target value. To judge the cylinder use time, the users may try to use operating time as a guide, but it is only an estimate. Furthermore, when the above mentioned gas cylinder is applied to a production line, once the gas in the cylinder is run empty without warning, then the gas supply will be interrupted. At this time, the production line will be forced to stop and must wait until a new gas cylinder is set again before the production line can resume operation. An unplanned shutdown will cause the production line to shutdown will also cause loss of production capacity. Risk of equipment damage is also possible.

Another sub-atmospheric gas supply system uses solid media packaged inside a cylinder to adsorb the processing fluid. The processing gas is desorbed by the user as needed. The cylinder is charged to a pressure less than atmospheric pressure to maintain sub-atmospheric conditions. However, the limitations of such systems are that the actual cylinder pressure is a related to temperature. As temperature rises, the internal pressure inside the cylinder rises. In such an example, storage and use temperatures above 25 C., the internal pressure of the cylinder can exceed atmospheric pressure and have positive pressure. Should the cylinder outlet valve be inadvertently opened, the positive pressure compressed fluid inside the cylinder will release and cause potential harmful conditions.

Therefore, what is clearly needed is a storage and delivery system that actively monitors the remaining gas volume in a cylinder and prevents the user from tampering with the pressure reduction regulator settings and maintains sub-atmospheric discharge pressure conditions and at all times that solves the problems mentioned above.

### BRIEF SUMMARY OF THE INVENTION

In one embodiment, the present invention provides a leak-proof fluid dispensing system with internal pressure sensor and pre-set dispensing pressure reducing regulator, and dispensing control valve structure. This invention mainly solves the problem whereas the conventional gas cylinder does not have a pressure sensor and cannot dynamically monitor the gas volume in the gas cylinder. In addition, the internal pre-set and fixed pressure reduction regulator will prevent tampering and accidental delivery pressure re-adjustment thereby creating a potential over-pressurization condition for downstream components, or potential gas release of the discharged fluid from the gas cylinder.

The present invention comprising a gas cylinder having a containing space and a bottle opening, and a dispensing control valve having an internal channel that communicates with an inlet port, an outlet port, a bottle port, and a joint portion, so that the bottle port is detachably communicated with the containing space, and the dispensing control valve is formed outside the bottle opening, wherein the internal of the dispensing control valve including an inlet valve connected to the inlet port and the internal channel, an outlet valve connected to the outlet port and an internal channel, and connects to a pressure dispensing reducing regulator attached to the dispensing control valve body, is connected to the outlet port and the bottle port through the internal channel and preset with an opening pressure value. When the actual pressure at the outlet end of the pressure dispensing regulator is lower than or equal to the opening pressure value, then the pressure dispensing reducing regulator is being opened, a filter connected to the inlet of the pressure dispensing reducing regulator and the bottle port through the internal channel, and a pressure sensor disposed on the dispensing body and having a detection end, and the detection end pressure—sensitively connected to the internal channel between the filter and the bottle port.

The present invention further provides a dispensing control valve structure with pressure sensor, including a dispensing body having an internal channel that communicates with an inlet port, an outlet port, a bottle port, and a joint portion which is detachably and can be sealed combined to the bottle opening, wherein the join portion is detachably connected to the bottle opening so that the bottle port is detachably communicated with the containing space, and the dispensing control valve body is formed outside the bottle opening, wherein the internal of the dispensing body including an inlet valve connected to the inlet port and the internal channel, an outlet valve connected to the outlet port and the internal channel, and a pressure dispensing regulator attached to the dispensing control valve body and connected to the outlet port and the bottle port through the internal channel and preset with an opening pressure value. When the actual pressure at the outlet end of the pressure dispensing regulator is lower than or equal to the opening pressure value, then the pressure dispensing regulator is being opened; a filter connected to the inlet of the pressure dispensing regulator and the bottle port through the internal channel: and a pressure sensor disposed on the dispensing valve body and having a detection end, and the detection end connected to the internal channel between the filter and the bottle port.

Implementation of the present invention at least produces the following advantageous effect:
1. It can reduce the possibility of accidental leakage or release of toxic liquids or gases.
2. It can eliminate the need for a pressure reducing regulator residing external of the cylinder and dispensing control valve thereby preventing the regulator from being re-adjusted or tampered with once the system is assembled.
3. By using the dispensing control valve, it is possible to control the supply of fluid in the cylinder when a flow supply is required.
4. When any kind of malfunctions or failures occur at the outlet valve, the leakage of fluid from the gas cylinder can be restricted.
5. It can dynamically provide the current storage pressure inside the gas cylinder, so that users can monitor the remaining volume of the fluid in the gas cylinder immediately.
6. It can eliminate the need for gas adsorbent materials in the gas cylinder.

### BRIEF DESCRIPTION OF THE SEVERAL VIEWS OF THE DRAWINGS

FIG. 1 is a detailed schematic representation of a leak-proof fluid dispensing system with a pressure sensor and a pre-fixed internal pressure reduction dispensing regulator:

FIG. 2 is a three-dimensional schematic representation of the leak-proof fluid dispensing system:

FIG. 3 is one of an embodiment diagram of the dispensing control valve with the attached pressure reduction regulator, filters and pressure sensor:

FIG. 4 is the other embodiment diagram of the dispensing control valve with the attached pressure reduction regulator, filters and pressure sensor:

FIG. 5 is a schematic representation of the start-up state of the dispensing control valve: and

FIG. 6 is a schematic representation of the leak-proof fluid dispensing system with a capillary installed on the inlet of the dispensing pressure reduction regulator.

### DETAILED DESCRIPTION OF THE INVENTION

The inventor provides a unique leak-proof fluid dispensing system with pre-set internal dispensing pressure reduction regulator and dispensing control valve structure with active pressure sensor for use in sub-atmospheric applications. This invention is particularly designed for the safe storage and distribution of toxic specialty gases utilized in the semiconductor ion implantation industry such as a compressed gas or liquefied compressed gas when using a storage container and a dispensing system, while monitoring the active cylinder gas pressure and available gas volume. The present invention is described in enabling detail in the following examples, which may represent more than one embodiment of the present invention.

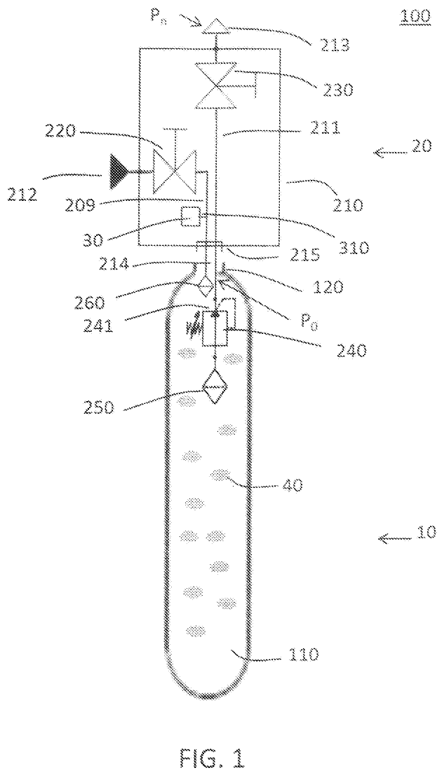

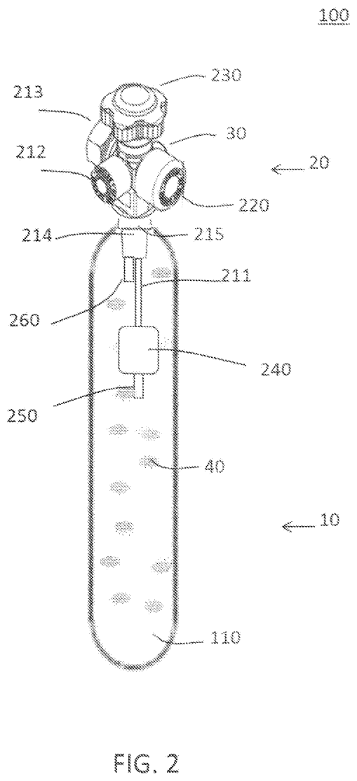

FIG. 1 to FIG. 2 is an embodiment of the invention for a leak-proof fluid dispensing system 100. The leak-proof fluid dispensing system 100 in this example comprises a gas cylinder 10: having a dispensing pre-set pressure reduction regulator 240, a dispensing control valve 20: and a pressure sensor 30.

In this example, the gas cylinder 10 has a containing space 110 and a bottle opening 120. The containing space 110 is used to store an industrial processing fluid 40 which can be a compressed liquid or a compressed gas and is generally a hazardous, toxic corrosive and/or flammable substance.

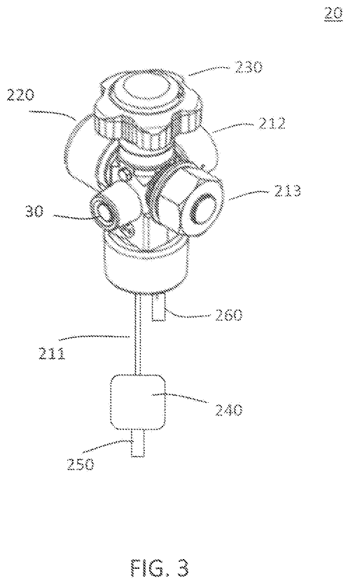

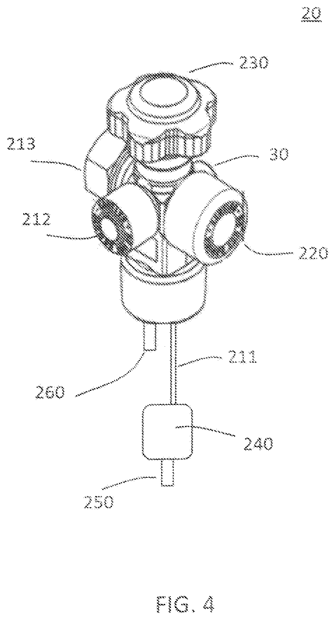

FIG. 3 to FIG. 4 is an embodiment of the present invention for a dispensing control valve 20 includes a dispensing body 210: an inlet valve 220: an outlet valve 230: a pressure reduction dispensing regulator 240: pressure sensor 30: and a regulator filter 250.

In this example, the dispensing body 210 may be a metal structure, and the dispensing body 210 includes an internal channel 211 that communicates with the outlet of pressure reduction dispensing regulator 240 and an outlet port 213. Control valve 20 with joint portion 215 connects to bottle port 214 for a leak proof connection.

The join portion 215, for example, a screw tooth, can be combined with the screw tooth of the bottle opening 120 through rotation, and the join portion 215 is detachably and sealed combined to the bottle opening 120. When the join portion 215 is combined to the bottle opening 120, the bottle port 214 is detachably communicated with the containing space 110, and the dispensing body 210 is formed outside the bottle opening 120.

The inlet valve 220 may be a general valve or a non-return valve that cannot exit but used for inlet only. The inlet valve 220 is connected to the inlet port 212 and the internal channel 209 and the inlet valve 220 is used to start or stop the inflow of upstream fluid from the inlet port 212 into the dispensing control valve 20. This activity is typically used by the gas charging facility when charging the cylinder 10 with the processing fluid 40. Under some conditions, the inlet valve 220 may also bypass the pressure dispensing regulator 240 and directly draw fluid from the gas cylinder 10 through the inlet valve 220.

The inlet valve 220 may be disposed, for example, at a position 90 degrees to the outlet valve 230 and the inlet valve 220 is managed by the gas charging plants rather than the user end. The inlet valve 220 is provided with an inlet opening/closing unit which can be opened or closed only by using an inlet-valve tool. The inlet-valve tools are only set up in the gas charging plant and the user end will not have the inlet-valve tool so that the user end has absolutely no opportunity to open or close the inlet valve 220.

In addition, the inlet port 212 is provided with an inlet protection cover, apart from protecting the inlet port 212 from damaged by being hit, the inlet protection cover generally used a metal gasket to maintain the sealed connected between the protection cover and the outlet port 213, adding a leak-proof guarantee for the inlet port 212.

Furthermore, because the inlet protection cover is provided, the inlet port 212 cannot be connected to any gas charging or pumping device connectors without the inlet protection cover being removed and it can avoid incorrect operation again.

The outlet valve 230 may be a general valve or a non-return valve that cannot enter but exit. The outlet valve 230 is connected to the outlet port 213 and the internal channel 211. The outlet valve 230 is used to start or stop the flow exiting of downstream fluid of the dispensing control valve 20.

The pressure dispensing regulator 240 is connected to the outlet port 213 and the bottle port 214 through the internal channel 211: the pressure dispensing regulator 240 has a preset opening pressure value and cannot be adjusted once the dispensing control valve 20 is attached to the cylinder 10. In general, when the actual pressure at the outlet end 241 of the pressure dispensing regulator 240 is lower than or equal to the opening pressure value, then the pressure dispensing regulator 240 is being turned on and opened at this time and the fluid in the gas cylinder 10 is allowed to flow out.

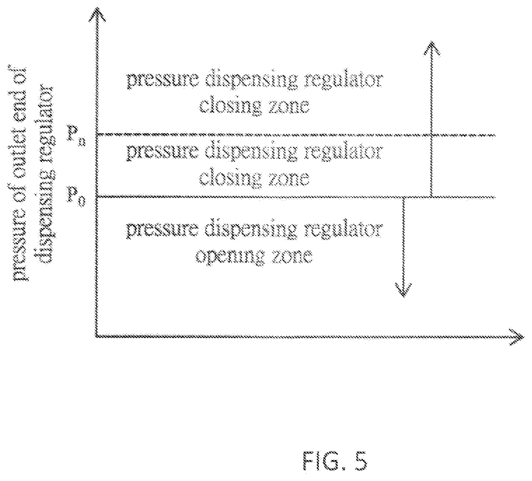

As shown in FIG. 5, also under some conditions to prevent leakage and increase safety. For example, in ion implantation applications, the opening pressure value is set or assigned as a first opening pressure value P, which is less than an atmospheric pressure. At this time, even if the outlet valve 230 is opened, but the actual pressure outside the outlet end 241 is equal to an atmospheric pressure so that the pressure dispensing regulator 240 is still closed and the fluid in the gas cylinder 10 will not flow out to prevent accidental leakage. The pressure dispensing regulator 240 will not be turned on until the outlet port 213 is connected to the user end, then the outlet port 213 is operated by the user end to create an user-end pressure value which is under an atmospheric pressure Pₙ and equal to or lower than the first opening pressure P, so that the fluid in the gas cylinder 10 is also allowed to flow out.

For example, the first opening pressure value P, is set as, for example, minus 0.5 psig which is lower than or equal to an atmospheric pressure Pₙ, 14.7 pounds per square inch (psig) . When the actual pressure of the outlet port 213 is lower than or equal to the first opening pressure value P₀ of minus 0.5 psig because of the user end equipment, the pressure dispensing regulator 240 allows the fluid in the gas cylinder 10 to flow out through its outlet end.

Due to the above-mentioned mechanism, during the storage or transportation of the gas cylinder 10 because the gas cylinder 10 is always in an atmospheric pressure Pₙ 14.7 psig storage and/or transportation environment. The pressure of outlet port 213 has not reached the first opening pressure value Pₙ, therefore, even if the outlet valve 230 is damaged or accidentally opened, there is no possibility that the fluid in the gas cylinder 10 leaks out.

Regarding the pressure dispensing regulator 240 described above, the setting of the opening pressure value is pre-set to the delivery pressure required for the operation of the downstream user's equipment. In order to prevent the fluid in the gas cylinder 10 from accidentally leaking from the outlet port 213 during the usual storage or transportation process, the outlet port 213 can be covered with the outlet protection cover again until the user end is ready to get the supply connection.

The regulator filter 250 is connected to the inlet of the pressure reducing dispensing regulator 240 and protects the pressure reducing dispensing regulator 240 from damaging particle intrusion in those cases where particles may be present in the fluid 40 contained within the cylinder 10. Since the pressure dispensing regulator 240 is a very delicate and sensitive unit, when the particle intrusion into the pressure dispensing regulator 240, it will make the pressure dispensing regulator 240 ineffective. Therefore, in order to protect the pressure dispensing regulator 240, a filter 250 may be provided at the intake end of the pressure dispensing regulator 240, which is connected to the pressure dispensing regulator 240 and the bottle port 214 through the internal channel 211, to filter the particles.

In a similar manner, an additional particle filter 260, is located on the outlet of the internal channel 209, that is used to charge the cylinder 10 with the target fluid 40. Filter 260 prevents the introduction of particles that may be present in target fluid 40 from entering the cylinder 10, during charging, in those cases where particles may be present in the fluid 40 used to charge the cylinder 10. Since the pressure dispensing regulator 240 is a very delicate and sensitive unit, when the particle intrusion into the pressure dispensing regulator 240, it will make the pressure dispensing regulator 240 ineffective. Therefore, in order to protect the pressure dispensing regulator 240, a filter 260 may be provided at the discharge end of the internal channel 209 and the inlet valve 220, which is connected to the dispensing control valve.

The pressure sensor 30 may be disposed on the dispensing body 210 in some cases where the fluid capacity in the gas cylinder 10 needs dynamically monitoring. A detection end 310 of the pressure sensor 30 is pressure sensitively connected to the internal channel 209 which is between the inlet valve 220 and the bottle port 214, thereby dynamically monitoring the volume of fluid in the gas cylinder 10. In this way, the preparation of the new gas cylinder 10 can be performed in advance, so as to avoid the production line being stopped and the loss caused because the process fluid cannot be smoothly supplied.

In some cases, as an example, the pressure reducing dispensing regulator 240 may be a diaphragm single-stage or dual-stage pressure regulator or a bellows pressure regulator or capillary or flow restrictor or similar pressure reduction component. As an alternate example, two or more pressure reducing dispensing regulator types may be installed in series or parallel to achieve the level of delivery pressure and flowrate control desired by the user. Also as an alternate example, the components mentioned above may be secured inside the dispensing control valve body to minimize space. However, the pressure reducing dispensing regulator remains pre-set and isolated from tampering by the user.

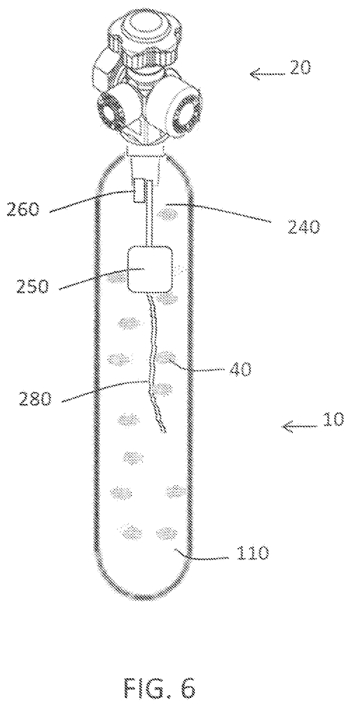

As shown in FIG. 6, for example, a capillary (280) selected by the length and inside diameter configuration is designed to reduce the pressure entering the pressure reducing dispensing regulator 240, when compared to the actual cylinder (10) pressure, allowing improved delivery pressure control of the pressure reducing dispensing regulator 240. A capillary (280) selected by the length and inside diameter configuration is designed to limit the flow rate through the capillary (280), thereby also limiting the uncontrolled release of the fluid from the dispensing control valve (20) upon system failure of the pressure reducing dispensing regulator 240.

Next, one of the embodiments is used for operation description.

Preparation for cylinder package assembly: For initial use the components of the leak-proof fluid dispensing system 100 are collected and assembled into the complete cylinder package 100. The opening pressure value of the pressure dispensing regulator 240 is preset to minus 0.5 psig. This regulator setting may be conducted by the pressure reducing dispensing regulator 240 manufacturers or the charging factory. The components are arranged in the configuration described above and the individual components are either welded or threaded together as applicable. Once the cylinder package 100 is assembled, the reducing dispensing regulator 240 is no longer adjustable or accessible, unless the cylinder package (100) is disassembled.

Preparation before charging operation: When the gas cylinder 10 is used by the user, the gas cylinder 10 will be transported to the charging plant and gas charging will be operated again. After the gas cylinder 10 delivered to the charging plant, it is necessary to use the key only available in the charging plant to remove the inlet protective cover before the charging operation to connect the charging device to the inlet port 212. The inlet-valve tool, which is only available in charging plant, must be used to open the inlet valve 220 before the charging operation can be performed.

Charging operation: The gas cylinder 10 will be filled by the inflation equipment of the charging plant until the pressure of the contents of the gas cylinder 10 is about 2,000 psig.

Pumping operation: In some cases, when the gas cylinder 10 must be pumped from the inlet port 212, before extracting air, similarly, it is also necessary to use a key only available in the charging plant to remove the inlet protective cover, than connect the discharging equipment to the inlet port 212. Finally, use the inlet valve tool only available in the discharging plant to open the inlet valve 220, then the pumping operation can be performed.

Storage or transportation of the gas cylinder 10: after charging or pumping is completed, the inlet-valve tool must be used again to close the inlet valve 220, then the gas port protective cover must be closed and locked again before the storage or transportation of the gas cylinder 10. Since the opening pressure value of the pressure dispensing regulator 240 has been preset to minus 0.5 psig the gas cylinder 10 is in an atmospheric pressure environment during the storage or transportation. Because the opening pressure value of the pressure dispensing regulator 240 is less than minus 0.5 psig, it can be ensure that the internal fluid of the gas cylinder 10 will not leak even if the outlet valve 230 is damaged or accidentally opened.

Preparation of gas cylinder 10 before use: After the gas cylinder 10 is delivered to the user end, the outlet protective cover of the gas cylinder 10 will be removed and then the outlet port 213 of the gas cylinder 10 will be connected with the equipment at the user's end.

User operation: After the gas cylinder 10 is connected to the user end device, the outlet valve 230 can be opened. At this time, the outlet of the pressure dispensing regulator 240 will detect the device pressure value of the user end, if it is less than or equal to, for example, minus 2.1 psig because the minus 2.1 psig is less than 0.5 psig, the first opening pressure value P₀ of the pressure dispensing regulator 240 so that the pressure dispensing regulator 240 will be turned on and the fluid in the gas cylinder 10 is supplied to the user equipment.

The above description is only the preferred embodiments of the present invention and is not intended to limit the present invention in any form. Although the invention has been disclosed as above in the preferred embodiment, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the spirit and scope of the technical solution of the present invention.

1. A leak-proof fluid dispensing system with pressure sensor and fixed dispensing pressure reducing regulator, comprising:
a gas cylinder having a containing space and a bottle opening: and
a dispensing control valve including:
a dispensing body having an internal channel that communicates with an inlet port, an outlet port, a bottle port, and a joint portion which is detachably and can be sealed combined to the bottle opening, so that the bottle port is detachably communicated with the containing space, and the dispensing body is formed outside the bottle opening, wherein the internal of the dispensing body including:
an inlet valve connected to the inlet port and the internal channel:
an outlet valve connected to the outlet port and the internal channel: and
a pressure dispensing reducing regulator connected to the outlet port and the bottle port through the internal channel and preset with an opening pressure value, when the actual pressure at the outlet end of the pressure dispensing regulator is lower than or equal to the opening pressure value, then the pressure dispensing regulator is being opened including:
a regulator filter connected to the inlet of the pressure dispensing regulator through the internal channel: and
a pressure sensor disposed on the dispensing body and having a detection end pressure sensitivity connected including:
a filter connected to the pressure dispensing regulator through the internal channel to the bottle port and inlet port.

2. The leak-proof fluid dispensing system as claimed in claim 1, wherein the opening pressure value is assigned as a first opening pressure value which is set lower than an atmospheric pressure, and when the actual pressure at the outlet end of the pressure reducing dispensing regulator is lower than or equal to the first opening pressure value, then the pressure reducing dispensing regulator is being opened.

3. The leak-proof fluid dispensing system as claimed in claim 1, wherein inlet of the pressure reducing dispensing regulator is further connected to a capillary.

4. The leak-proof fluid dispensing system as claimed in claim 2, wherein the pressure reducing dispensing regulator is further connected to a capillary.

5. A dispensing control valve structure with pressure sensor including:
a dispensing body having an internal channel that communicates with an inlet port, an outlet port, a bottle port, and a joint portion which is detachably and can be sealed combined to the bottle opening, wherein the join portion is detachably connected to the bottle opening so that the bottle port is detachably communicated with the containing space, and the dispensing body is formed outside the bottle opening, wherein the internal of the dispensing body including:
an inlet valve connected to the inlet port and the internal channel:
an outlet valve connected to the outlet port and the internal channel: and
a pressure dispensing reducing regulator connected to the outlet port and the bottle port through the internal channel and preset with an opening pressure value, when the actual pressure at the outlet end of the pressure dispensing regulator is lower than or equal to the opening pressure value then the pressure dispensing regulator is being opened including:
a regulator filter connected to the inlet of the pressure dispensing regulator through the internal channel: and
a pressure sensor disposed on the dispensing body and having a detection end pressure sensitivity connected including:
a filter connected to the pressure dispensing regulator through the internal channel to the bottle port and inlet port.

6. The dispensing control valve structure as claimed in claim 5, wherein the pressure reducing dispensing regulator opening pressure value is assigned as a first opening pressure value which is set lower than an atmospheric pressure, and when the actual pressure at the outlet end of the pressure dispensing regulator is lower than or equal to the first opening pressure value, then the pressure dispensing reducing regulator is being opened.

7. The dispensing control valve structure as claimed in claim 5, wherein the inlet of the pressure reducing dispensing regulator is further connected to a capillary.

8. The dispensing control valve structure as claimed in claim 6, wherein the inlet of the pressure reducing dispensing regulator is further connected to a capillary.

9. A dispensing control valve structure, including:
a dispensing body having an internal channel that communicates with an inlet port, an outlet port, a bottle port, and a joint portion which is detachably and can be sealed combined to the bottle opening, wherein the join portion is detachably connected to the bottle opening so that the bottle port is detachably communicated with the containing space, and the dispensing body is formed outside the bottle opening, wherein the internal of the dispensing body including:
an inlet valve connected to the inlet port and the internal channel;
an outlet valve connected to the outlet port and the internal channel: and
a pressure dispensing reducing regulator connected to the outlet port and the bottle port through the internal channel and preset with an opening pressure value, when the actual pressure at the outlet end of the pressure dispensing regulator is lower than or equal to the opening pressure value then the pressure dispensing regulator is being opened including:
a filter connected to the pressure dispensing regulator through the internal channel to the bottle port and inlet port.

10. The dispensing control valve structure as claimed in claim 9, wherein the pressure reducing dispensing regulator opening pressure value is assigned as a first opening pressure value which is set lower than normal atmospheric pressure, and when the actual pressure at the outlet end of the pressure dispensing regulator is lower than or equal to the first opening pressure value, then the pressure dispensing reducing regulator is being opened.

11. The dispensing control valve structure as claimed in claim 9, wherein the inlet of the pressure reducing dispensing regulator is further connected to a capillary.

12. The dispensing control valve structure as claimed in claim 10, wherein the inlet of the pressure reducing dispensing regulator is further connected to a capillary.
